(19) United States
(12) Patent Application Publication
(10) Pub. No.: US 2008/0209057 A1
(43) Pub. Date: Aug. 28, 2008

(54) System and Method for Improved Internet Content Filtering

(76) Inventors: Paul Martini, Escondido, CA (US); Peter Martini, Escondido, CA (US)

Correspondence Address: WILLIAM J. KOLEGRAFF, 3119 TURNBERRY WAY, JAMUL, CA, 91935, US

(21) Appl. No.: 11/863,474

(22) Filed: Sep. 28, 2007

Related U.S. Application Data
(60) Provisional application No. 60/827,274, filed on Sep. 28, 2006.

(51) Int. Cl. G06F 15/16

(52) U.S. Cl. 709/229

(57) ABSTRACT

Briefly, the present invention provides a system and methods for filtering internet content. The system has an internet connection filter device that filters information being transmitted on the connection between one or more computers and the internet. The device stores rules on permissible and impermissible categories of content in local memory. The device detects and holds back DNS and ‘get’ requests from the one or more computers to the internet. The device requests the categories of content associated with the URL's in the DNS and ‘get’ requests from and internet server. The device applies the locally stored rules to the DNS and ‘get’ requests based on the categories of content received from the internet server.

### BACKGROUND

1. Field

This application claims priority to U.S. patent application 60/827,274, filed Sep. 28, 2006, and entitled “System and Method for Improved Internet Content Filtering”, which is incorporated herein. The present invention relates generally to the field of the internet, and more particularly to internet content filtering.

2. Description of Related Art

The internet is widely used and has become an essential aspect of modern life. Information and services available on the internet are used for work, personal activities, and as a way to keep in contact with friends and family. As the accessibility, functionality, and content of the internet expand, its use and acceptance continue to grow. Regrettably, negative aspects of the internet such as access to objectionable content, malicious software, and identity theft have grown as well. As reliance on the internet increases, so does the demand of users to be able to control the accessibility of internet content from their computers. Users demand filters that allow them to gain the benefits of the internet while blocking out the negative aspects. In situations where multiple computers share a connection to the internet, users demand the ability to filter the content accessed by the several computers. Users demand filters that provide a high quality of service at a minimal price.

The price of filters and the quality of service they provide depend in part on their physical implementation and the ways they distinguish between acceptable and objectionable content. For example, filters may be implemented as hardware affecting the internet connection of one or more computers. Further, these filters may restrict access to content based on assessments of content, on the protocol used to transfer the content, or on other criteria. Users have an expectation that the filters they use will be reasonably priced, that they will only block objectionable content and services, and that they will not be burdensome to implement or use.

Unfortunately, the known systems and processes for filtering internet content to one or more computers lead to an unsatisfactory user experience. Traditional filters implemented in hardware require expensive components to enable filtering. For example, hard drives are used to store information to enable content filtering. These hard drives significantly increase the size and cost of traditional filtering devices. Therefore, internet filter users have a need for an improved system and methods for filtering internet content.

### SUMMARY

Briefly, the present invention provides a system and methods for filtering internet content. The system has an internet connection filter device that filters information being transmitted on the connection between one or more computers and the internet. The device stores rules defining permissible and impermissible categories of content in local memory. The device detects and holds back DNS and ‘get’ requests from the one or more computers to the internet. The device requests the categories of content associated with the URL's in the DNS and ‘get’ requests from and internet server. The device applies the locally stored rules to the DNS and ‘get’ requests based on the categories of content received from the internet server.

In a particular example, the internet connection filter device is connected in series to a single computer and to a modem that connects to the internet. A user establishes a rule for the filter that websites that offer shopping are to be blocked. The user subsequently attempts to access a website that offers shopping. The internet connection filter device detects the attempt to request the site, extracts the URL for the site from the request, and requests the categories of content associated with the URL from an internet server. The internet connection filter device receives the response from the internet server which states that the requested URL is associated with shopping. The internet connection filter device applies the pre-determined rule blocking sites that offer shopping and blocks access to the site.

Advantageously, the present system and methods provide users with internet filters that offer an improved quality of service. Since the content categories associated with different URLs are stored remotely, the internet connection filter device can be relatively small and inexpensive. In this way, the cost and inconvenience of using the filter decreases and the user satisfaction increases.

### BRIEF DESCRIPTION OF THE SEVERAL VIEWS OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram of a system for enabling improved internet content filtering in accordance with the present invention.

FIG. 2 is a flow chart of a process for improved internet content filtering in accordance with the present invention.

FIG. 3 is a flow chart of another process for improved internet content filtering in accordance with the present invention.

FIG. 4 is a flow chart of another process for improved internet content filtering in accordance with the present invention.

FIG. 5 is a flow chart of a process for enabling improved internet content filtering in accordance with the present invention.

FIG. 6 is another block diagram of a system for enabling improved internet content filtering in accordance with the present invention.

FIG. 7 is another block diagram of a system for enabling improved internet content filtering in accordance with the present invention.

FIG. 8 is another block diagram of a system for enabling improved internet content filtering in accordance with the present invention.

### DETAILED DESCRIPTION OF THE INVENTION

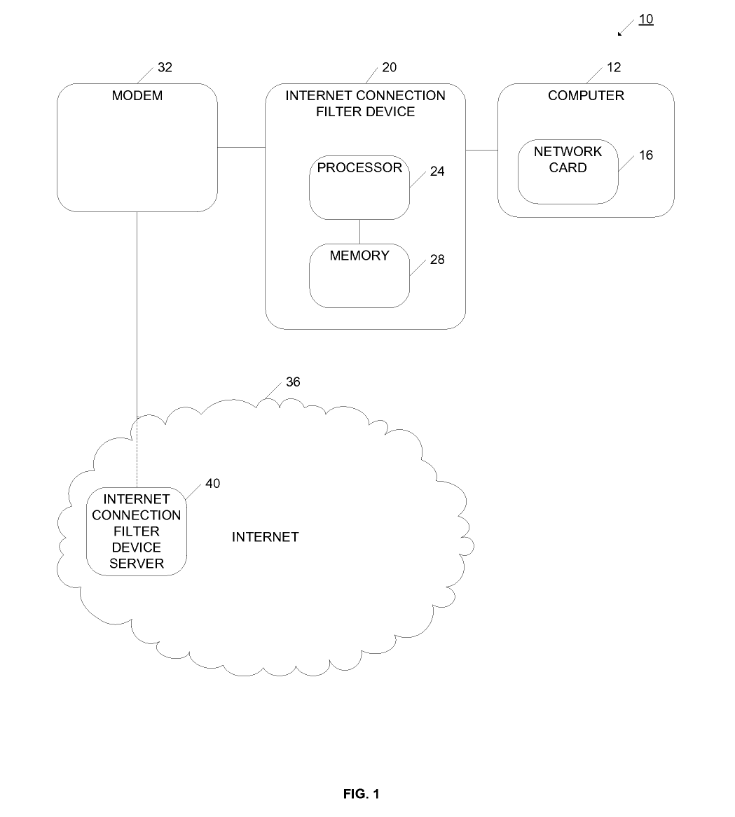

Referring now to FIG. 1, system 10 for enabling improved internet content filtering is illustrated. System 10 has internet connection filter device 20 configured to filter the communications between computer 12 and internet 36. Internet connection filter device 20 has processor 24 and memory 28. It will be appreciated that processor 24 may be a single device or that its functionality may be distributed among two or more processing devices, or the processor functionality may be provided by a gate array or some other programmable device. It will also be appreciated that memory 28 may be implemented as a single block of memory or that its functionality may be distributed among two or more blocks of memory. It will be further appreciated that some or all of the memory may be volatile or non-volatile, and that it may be implemented using optical, magnetic, or other storage technology.

Rules for filtering internet content are stored in memory 28 of internet connection filter device 20. In one example, the rules are based on categories of internet content that should or should not be blocked. These categories may include, but are not limited, to adult, audio/video, web chat, dating, drugs, entertainment, finance, forums, gambling, games, illegal, jobs, news, private, proxies, shopping, sports, travel, violence, warez/hacking, and webmail. In one example, the rules stored in memory 28 in internet connection filter device 20 are yes/no indications of whether a particular each content category should be blocked.

Internet connection filter device 20 is connected to computer 12. It will be appreciated that this connection may be established using a physical connection such as a Cat-5 cable according to the EIA/TIA 5688 standard or according to wireless communication standards such as IEEE 802.11. Computer 12 has network card 16 configured for communication with internet 36. It will be appreciated that computer 12 may be a desktop computer, a laptop computer, a personal data assistant, or other device capable of accessing internet 36. It will be further understood that network card 16 may be configured to communicate according to wired or wireless standards such as EIA/TIA 568 or IEEE 802.11 and may be an integrated part of computer 12 or may be removable.

Internet connection filter device 20 is also connected to modem 32. It will be appreciated that this connection may be established using a physical connection according to standards such as EIA/TIA 568 or according to wireless communication standards such as IEEE 802.11. Modems are well known in the art and will not be described in detail. However, generally, convert information being transmitted in a digital protocol to an analog protocol. For instance, a modem may convert signals being transmitted across a DSL line into signals suitable for transmission on a Cat-5 line. It will be understood that modem 32 may convert between protocols corresponding to technologies such as DSL, cable, standard phone lines, Cat-5 cables, and others.

Modem 32 is connected to internet 36. The infrastructure enabling the functionality of internet 36 is known in the art and is not illustrated here. Means by which computers are assigned IP addresses are also known in the art and will not be discussed in detail. However, generally, internet service providers are responsible for assigning IP addresses to computers. This may occur when the computer first attempts to access the internet or at other times. In one example, internet connection filter device 20 passively observes as computer 12 is assigned an IP address by the internet service provider and then uses the IP address assigned to computer 12 as its own. In another example, an IP address can be manually assigned to internet connection filter device 20 by a user.

Via internet 36 and modem 32, internet connection filter device 20 can connect to internet connection filter device server 40. Internet servers are known in the art and will not be described in detail. However, generally, internet servers host information that they send out in response to requests they receive from devices. It will be understood that the functionality of internet connection filter device server 40 may be accomplished by a single server or by two or more servers. In one example, internet connection filter device 20 connects to internet connection filter device server 40 soon after obtaining an IP address and maintains an open session during normal operation. During periods without interaction, the connection persists as a stateless, active session. In another example, internet connection filter device 20 connects to internet connection filter device server 40 opens a session and then closes the session each time it makes a makes a request and receives a response.

Internet connection filter device server 40 maintains information that enables internet connection filter device 20 to filter the content accessible to computer 12. In one example, internet connection filter device server 40 maintains a database of URL's and the contents of category associated with the URL's. For example, the database will store information indicating that a particular URL is associated with the shopping and travel categories of content. Continuing in the example, if the user attempts to access that particular URL from computer 12, internet connection filter device 20 will detect the attempt. Internet connection filter device 20 will request the categories of content associated with that particular URL from internet connection filter device server 40. Internet connection filter device server 40 will respond, telling internet connection filter device 20 that that particular URL is associated with the shopping and travel categories of content. Finally, if no rule stored in memory 28 of internet connection filter device 20 indicates that the shopping or travel category of content is selected to be blocked, internet connection filter device 20 will allow computer 12 to access that particular URL.

Advantageously, storing the categories of content remotely on internet connection filter device server 40 reduces the complexity and cost of constructing and maintaining internet connection filter device 20. Traditional filters implemented in hardware need memory large enough to hold the entire database of URL's and the contents of categories associated with them. Hard drives capable of storing that much information and accessing it quickly are expensive. The present invention enables internet connection filter devices to share access to a single centralized database. By sharing a database, the cost of hardware capable of maintaining the database is distributed over many internet connection filter devices. Additionally, when URL's are created, destroyed, or changed, the database of URL's and the categories of content associated with them must be updated. Traditional hardware filters that maintain a copy of the database locally must each be updated individually at great cost to of time and resources. With internet connection filter device server 40, the centralized database only has to be updated once in order for the internet connection filter devices to have access to the most up to date, accurate information. These updates can be done with no effort or expense to the individual users. A centralized database on internet connection filter device server 40 decreases the cost per unit of internet connection filter device 20 and the cost of updating internet connection filter device 20 to use the most current information. This diminished cost and increased functionality increases user satisfaction.

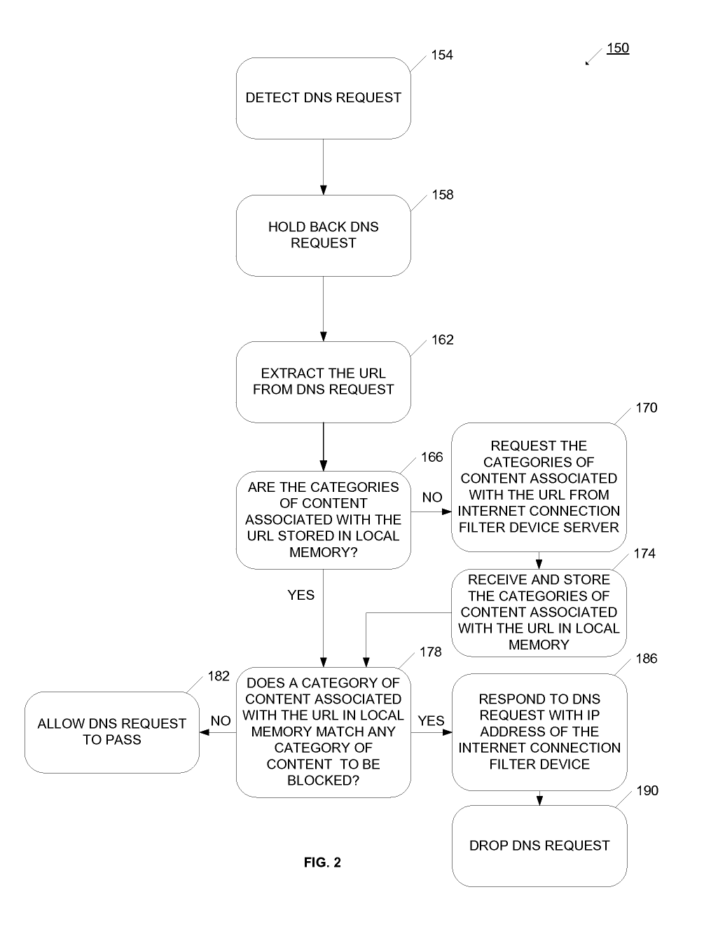

Referring now to FIG. 2, method 150 for improved internet content filtering is illustrated. In method 150, the internet connection filter device detects a DNS request from the computer as shown in block 154. The DNS system is known in the art and will not discussed in detail. However, generally, when a computer wants to access content on the internet, but does not know the IP address of the server that hosts the content, it sends out a DNS request. DNS servers work to determine the IP address of the server hosting the content and return the IP address to the requesting computer.

After detecting the DNS request from the computer, the internet connection filter device holds back the DNS request as shown in block 158. It will be understood that DNS requests may be spread out over one or more packets. The use of packets for communication in computer networks is well known and will not be discussed in detail. However, generally, messages sent in computer networks are broken into pieces called packets. In one example, if the DNS request is spread out over two or more packets, the internet connection filter device will reassemble the packets to reconstruct the entire DNS request. In another example, the one or more packets constituting the DNS request will be stored in temporary memory for processing while other packets and requests are being handled.

After holding back the DNS request, the internet connection filter device will extract the URL from the DNS request. The URL in a DNS request is just the domain of the server hosting the desired content. The domain system is know in the art and will not be discussed in detail. However, generally, the servers that constitute the internet are organized into different domain levels. For example, top level domains include .com, .org, .net, .gov, .edu and others. Within each of the top level domains, more levels of domains can be specified.

After extracting the URL from the DNS request, the internet connection filter device determines if the categories of contents associated with that URL are already stored in local memory. In one example, a portion of memory in the internet connection filter device is dedicated to storing the categories of content associated with URL's that the computer has recently attempted to access. Advantageously, this prevents the internet connection filter device from having to request the categories of content associated with URL's that it frequently accesses. In one example, the memory used to store URL's and the categories of content associated with them is organized as a hash table.

If the categories of content associated with the URL from the DNS request are not stored in local memory, the internet connection filter device requests the categories of content associated with the URL from the internet connection filter device server shown in block 170. After requesting the categories of content associated with the URL from the internet connection filter device server, the internet connection filter device receives the response from the internet connection filter device server and stores the categories associated with the URL in local memory as shown in block 174. In one example, where the URL's and the categories of contents associated are stored in a hash table, collisions are dealt with by overwriting the previous entry. Advantageously, because the memory overwrites itself with the most current information it never has to be purged.

Whether the categories of content associated with the URL in the DNS request were already stored in local memory of the internet connection filter device from a previous request or whether the categories of content associated with the URL had to be requested from the internet connection filter device server and subsequently stored, with the categories of content in local memory the internet connection filter device can determine if a category of content associated with the URL match any of the categories set to be blocked as shown in block 178. Again, the URL extracted from the DNS request will be a domain. Filtering by domain is a very restrictive because not all web pages in a given domain will necessarily contain the same categories of content. In one example, categories of content are only associated with an entire domain if essentially all of the content in the domain falls into one or more the categories of content. If none of the categories of content associated with the URL are designated to be blocked, the internet connection filter device allows the DNS request to pass as shown in block 182.

If a category of content associated with the URL in local memory matches a category of content to be blocked, the internet connection filter device responds to the DNS request with the IP address of the internet connection filter device. In one example, when the computer tries to access any content by sending a request to the IP address of the internet connection filter device, the internet connection filter device responds with a message indicating that the requested content cannot be accessed. After responding to the DNS request with the IP address of the internet connection filter device, the internet connection filter device drops the actual DNS request.

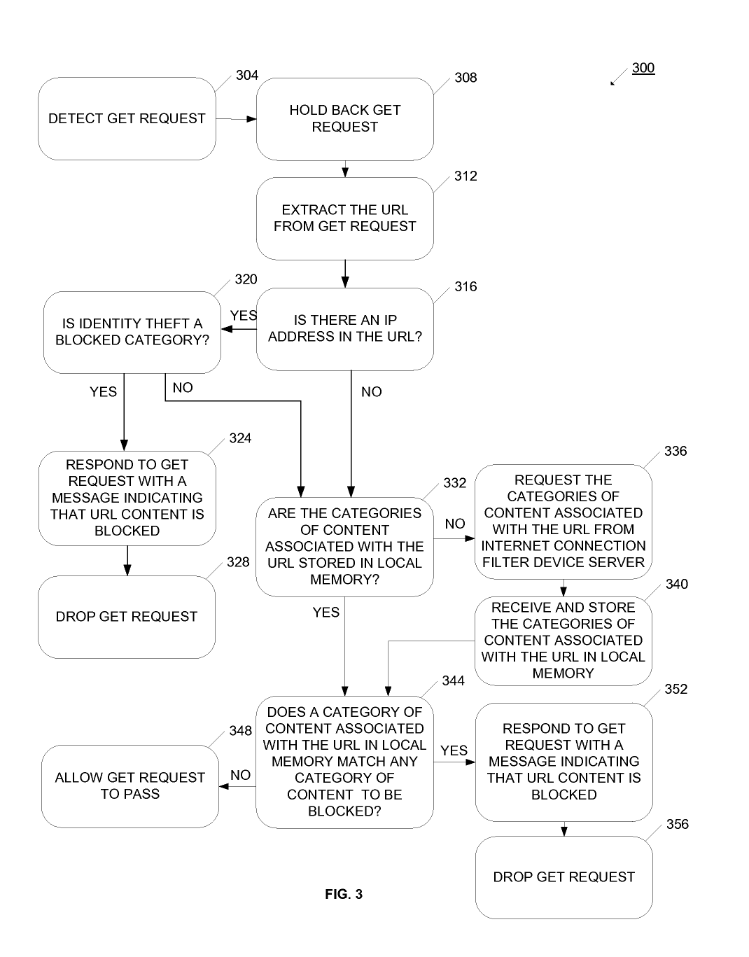

Referring now to FIG. 3, method 300 for improved internet content filtering is illustrated. In method 300, the internet connection filter device detects a get request from the computer as shown in block 304. Get requests are known in the art and will not be discussed in detail. However, generally, get requests are used in the HTTP protocol for a computer to request files from a server on the internet. In current versions of the HTTP protocol, the entire URL of the requested file must be included in the get request.

After detecting the get request, the internet connection filter device holds back the get request as shown in 308. It will be understood that get requests may be spread out over one or more packets. In one example, if the get request is spread out over two or more packets, the internet connection filter device will reassemble the packets to reconstruct the entire get request. In another example, the one or more packets constituting the get request will be stored in temporary memory for processing while other packets and requests are being handled. After holding back the get request, the internet connection filter device the URL from the get request as shown in block 312.

After extracting the URL from the get request, the internet connection filter device determines if there is an IP address in the URL as shown in block 316. It will be understood that identity thieves often use URL's with IP addresses in them to steal sensitive information. Because of the way domains are administered, registering a domain often leaves incriminating evidence against identity thieves. As a result, thieves will forego registering a domain and set up a server with an IP address. In the email and other materials they propagate, identity thieves will embed the IP address of their server in links. Users following the links may be coerced into surrendering sensitive information at great cost to finances and time. In one example, the internet connection filter device is designed to help prevent identity theft by restricting access to URL's that contain IP addresses in them.

If the URL contains an IP address, the internet connection filter device determines if identity theft is a blocked category as shown in box 320. If so, the internet connection filter device responds to the get request with a message indicating that the requested URL content is blocked. In one example, message indicating that the requested URL is blocked is formatted in HTML as a webpage. In another example, the message is sent back by the internet connection filter device as if the server hosting the requested URL had responded to the get request with the message. After responding to the computer, the internet connection filter device drops the get request as shown in box 238.

If the URL does not contain an IP address or if identity theft is not a blocked category of content, the internet connection filter device determines if the categories of content associated with the URL are stored in local memory as shown in box 332. If the categories of content associated with the URL are not stored locally, the internet connection filter device requests the categories of content associated with the URL from the internet connection filter device server as shown in box 336. The internet connection filter device then receives the reply from the internet connection filter device server and stores the categories of content associated with URL in local memory as shown in box 340.

After determining that the categories of content associated with the URL were already stored in local memory or recently storing them, the internet connection filter device determines if a category of content associated with URL matches any category of content to be blocked as shown in box 344. If no category of content associated with the URL matches a blocked category, the internet connection filter device allows the get request to pass according to box 348. However, if a category of content associated with the URL matches a blocked category, the internet connection filter device responds to the computer with a message indicating that the URL content is blocked as shown in box 352. Subsequently, the internet connection filter device drops the actual get request as shown in box 356.

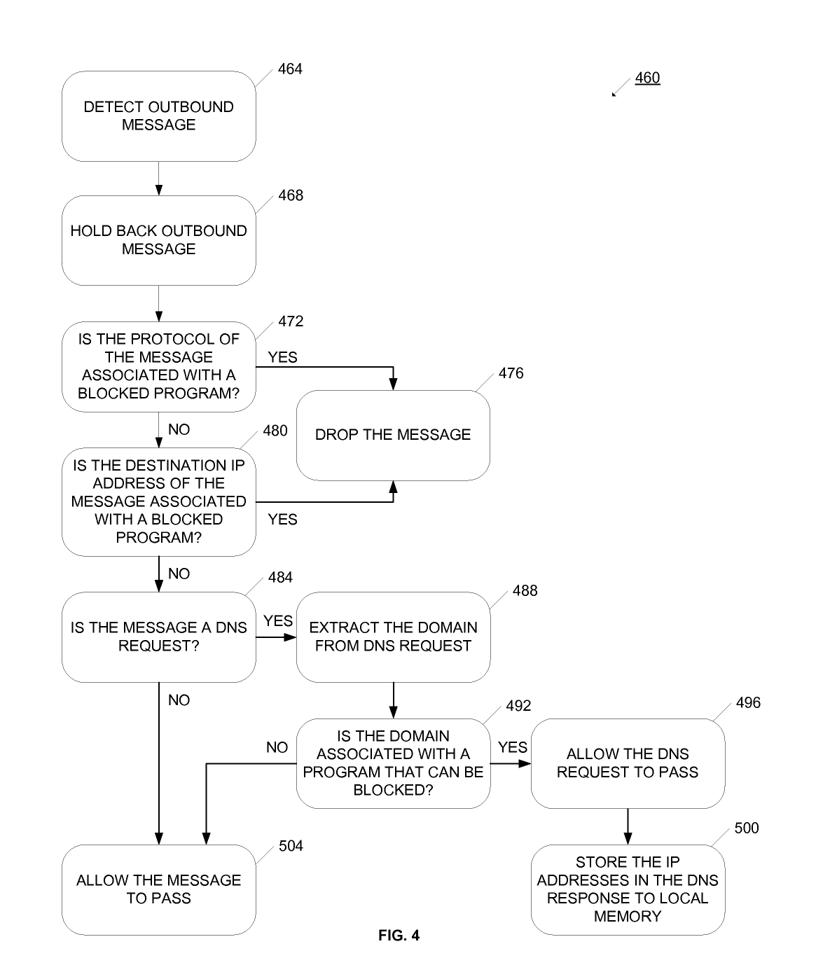

Referring now to FIG. 4, method 460 for improved internet content filtering is illustrated. In method 460, the internet connection filter device detects an outbound message as shown in box 464. It will be understood that the message may follow protocols such as DNS, HTTP, FTP, and others. It will be further understood that the message may consist of one or more packets. After detecting the outbound message, the internet connection filter device holds back the message as indicated in box 468. In one example the message is reconstructed from one or more packets and stored in temporary memory while being processed.

After holding back the message, the internet connection filter device determines if the protocol of the message is associated with a program to be blocked as shown in box 472. It will be understood that programs on computers may use different protocols for communicating over the internet. For example, they may communicate according to protocols such as HTTP, FPT, DNS, and others. In one example, a portion of memory in the internet connection filter device is dedicated to storing information on the protocols used by programs that can be blocked. The internet connection filter device compares the protocol of the message being held back with the protocols it has information on in its memory. If the protocol of the message is associated with a blocked program, the internet connection filter device will drop the message as shown in box 476. Dropping the message will disrupt the operation of the blocked program.

If the protocol of the message does not correspond to a blocked program, the internet connection filter device determines if the destination IP address of the message is associated with a blocked program. In one example, a portion of memory in the internet connection filter device is dedicated to storing IP addresses of servers that are used by programs that can be blocked. The internet connection filter device compares the destination IP address of the message with this list of IP addresses it keeps in memory. If the destination IP address matches an IP address used by a program to be blocked, the internet connection filter device drops the message as shown in box 476. Dropping the message will disrupt the operation of the blocked program.

If the destination IP address of the message being held back is not associated with a blocked program, the internet connection filter device determines if the message is a DNS request as shown in box 484. If the message is a DNS request, the internet connection filter device extracts the domain from the DNS request as shown in box 488. After extracting the domain from the DNS request, the internet connection filter device determines if the domain is associated with a program that can be blocked as shown in box 492. In one example, a portion of memory the internet connection filter device is dedicated to storing domains associated with programs that can be blocked. If the domain from the DNS request matches a domain a domain associated with a program that can be blocked, the internet connection filter device allows the DNS request to pass as shown in box 496. Upon detecting the DNS response, the internet connection filter device stores the one or mores IP addresses in the response to local memory and associates them with the program that generated the DNS request as shown in box 500. Storing the IP addresses from the DNS response enables the internet connection filter device to block a program that attempts to access those IP addresses in the future.

If the message being held back is not a DNS request or if the domain in the DNS request is not associated with a program that can be blocked, the internet connection filter device allows the message to pass as shown in block 504.

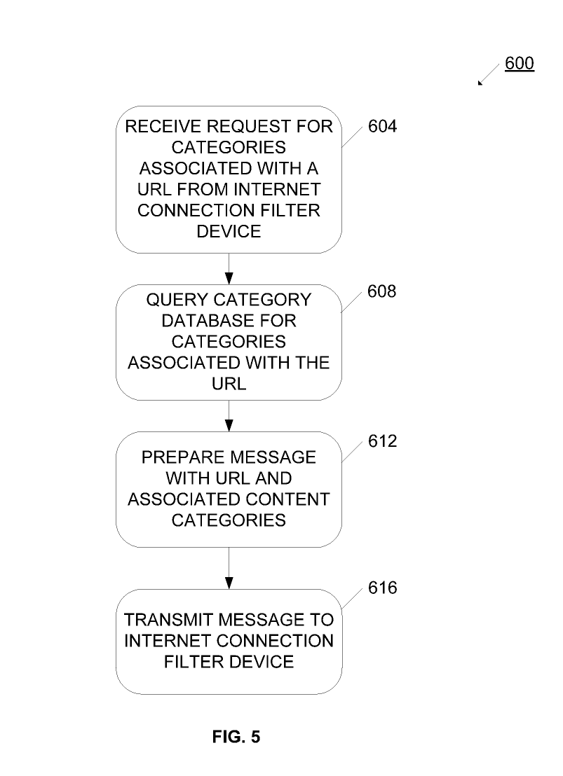

Referring now to FIG. 5, method 600 for enabling improved internet content filtering is illustrated. In method 600, the internet connection filter device server receives a request for categories associated with a URL from an internet connection filter device as shown in box 604. It will be understood that the request message may be communicated according to a variety of protocols. In one example, the request contains only the IP address of the internet connection filter device making the request and the URL whose associated categories of content are unknown to the internet connection filter device. In another example, the request may be encrypted using any of a variety of encryption techniques to enhance security.

After receiving a request, the internet connection filter device server extracts the URL from the request and queries the category database for the categories of content associated with the URL from the request. In one example, if the database does not have information on the requested URL, the internet connection filter device server informs the entity that maintains the content of the database so that the categories of content associated with the URL can be determined for future requests.

After querying the database, the internet connection filter device server prepares a message containing the requested URL and the categories of content associated with it as shown in box 612. In one example, if the requested URL is a domain that hosts content corresponding to a wide variety of content categories, the internet connection filter device server may choose indicate that the URL is not associated with any particular category of content. This prevents the internet connection filter device from blocking access to potentially many unblocked categories of content in order to block access to a small number of blocked categories. Preventing access to the categories designated to be blocked is done when the computer attempts to access URL's that are more specific than just a domain.

After preparing the message, the internet connection filter device server transmits the message back to the internet connection filter device as shown in box 616.

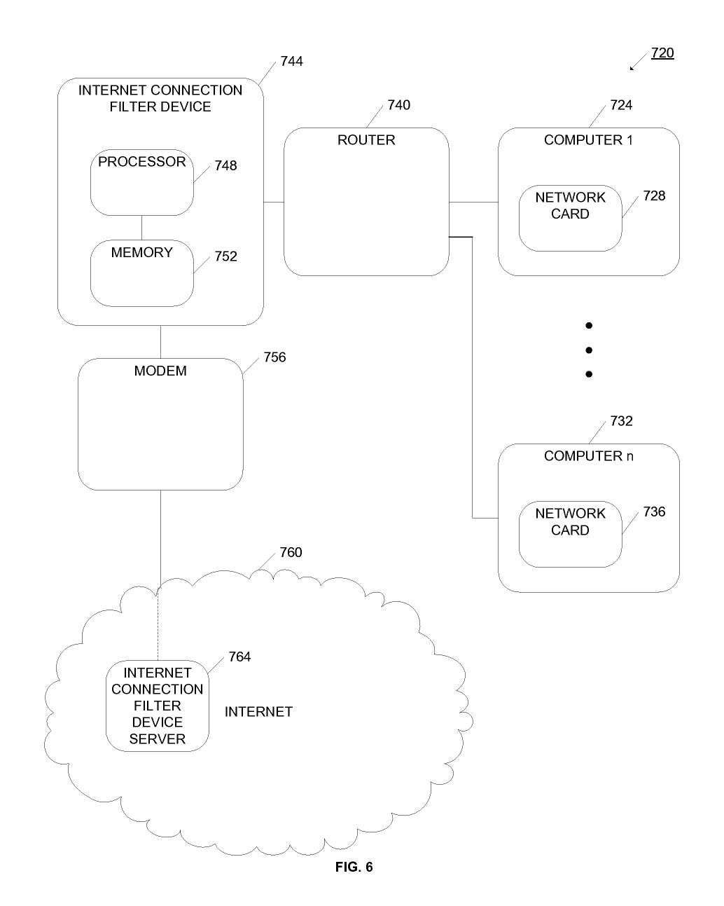

Referring now to FIG. 6, system 720 for enabling improved internet content filtering is illustrated. System 720 has internet connection filter device 744. Internet connection filter device 744 is connected to modem 756. It will be understood that this connection may be a physical connection according to standards such as EIA/TIA 568 or that it may be a wireless connection operating according to standards such as IEEE 802.11. It will be further understood that modem 756 may convert between such standards as DSL, cable, phone lines, and EIA/TIS 568. Modem 756 is connected to internet 760 and internet connection filter device 764.

Internet connection filter device 744 is also connected to router 740. It will be understood that this connection may be a physical connection according to standards such as EIA/TIA 568 or that it may be a wireless connection operating according to standards such as IEEE 802.11. Routers are known in the art and will not be discussed in detail. However, generally, routers in computer networks allow multiple computers to share a single connection to the internet. To do this, routers assign IP addresses to each of the computers and manage traffic between each of the computers and the internet. The processes by which routers assign IP addresses to computers and are assigned IP addresses by internet service providers are also know in the art and will not be discussed in detail. However, generally, an internet service provider will assign an IP address to a router when it first attempts to access the network. Then the router assigns IP addresses to the computers connected to it. In one example, internet connection filter device 744 passively observes as router 740 is assigned an IP address by the internet service provider and then uses the IP address assigned to router 740 as its own. In another example, an IP address can be manually assigned to internet connection filter device 744 by a user.

Computer 724 and computer 732 represent one or more computers connected to router 740. It will be understood that these connections may be physical connections according to standards such as EIA/TIA 568 or that they may be wireless connections operating according to standards such as IEEE 802.11.

In this configuration, internet connection filter device 744 can filter the internet traffic of all the computers connected to router 740. Advantageously, only one set of rules needs to be defined by users and only one internet connection filter device must be used to filter the content of every computer on the network. This savings in cost and effort greatly increases user satisfaction. Further, because no software is required to use or maintain internet connection filter device 744, it can be deployed in existing networks with minimal effort. Also, because internet connection filter device 744 can provide filtering without using a firewall it can be deployed in existing networks without necessitating other changes to network organization.

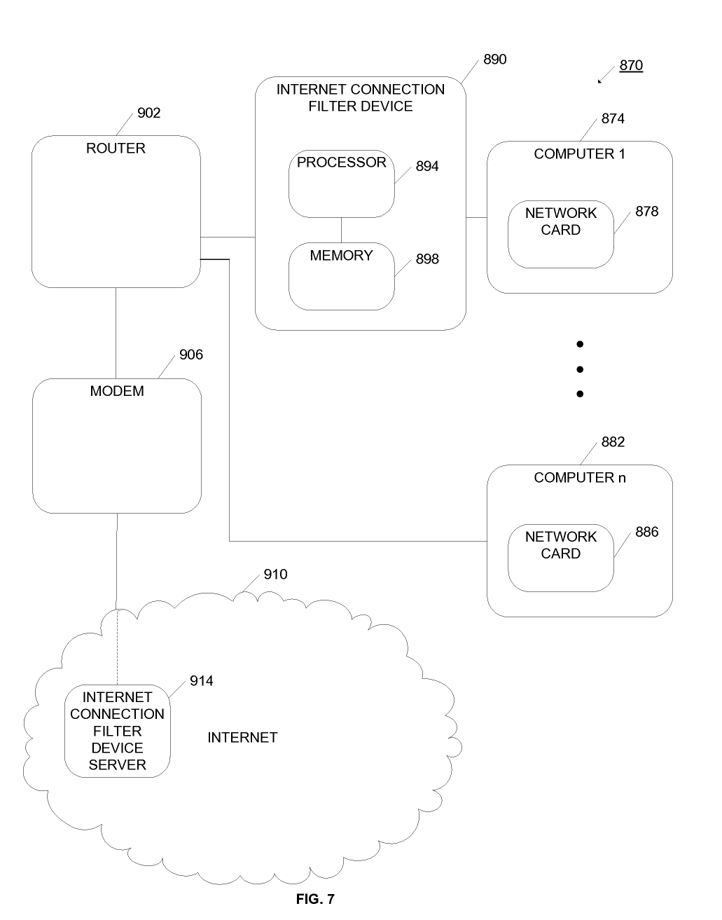

Referring now to FIG. 7, system 870 for enabling improved internet content filtering is illustrated. System 870 has router 902 connected to modem 906. It will be appreciated that the connection between router 902 and modem 906 may be a physical connection according to standards such as EIA/TIA 568 or a wireless connection according to standards such as IEEE 802.11. It will be further understood that modem 906 may convert between such standards as DSL, cable, phone lines, and EIA/TIS 568. Modem 906 is connected to internet 910 and internet connection filter device server 914.

Router 902 is also connected to internet connection filter device 890 and to zero, one, or more other computers represented by computer 882. It will be appreciated that these connections may be physical connections according to standards such as EIA/TIA 568 or wireless connections according to standards such as IEEE 802.11. Internet connection filter device 890 is also connected to computer 874. It will also be appreciated that the connection between internet connection filter device 890 and computer 874 may be a physical connection according to standards such as EIA/TIA 568 or a wireless connection according to standards such as IEEE 802.11. In another example, an IP address can be manually assigned to internet connection filter device 890 by a user.

In this configuration, zero, one or more of the computers on the network bypass internet connection filter device 890. by connecting directly to router 902. Advantageously, this configuration enables the flexibility to filter content on a subset of the computers attached to the network. In one example, computer 874 may belong to a young child and computer 882 may belong to the child's parent. This configuration slows the parent to restrict the child's access to content on the internet from computer 874 without limiting his or her own access to content on the internet from computer 882.

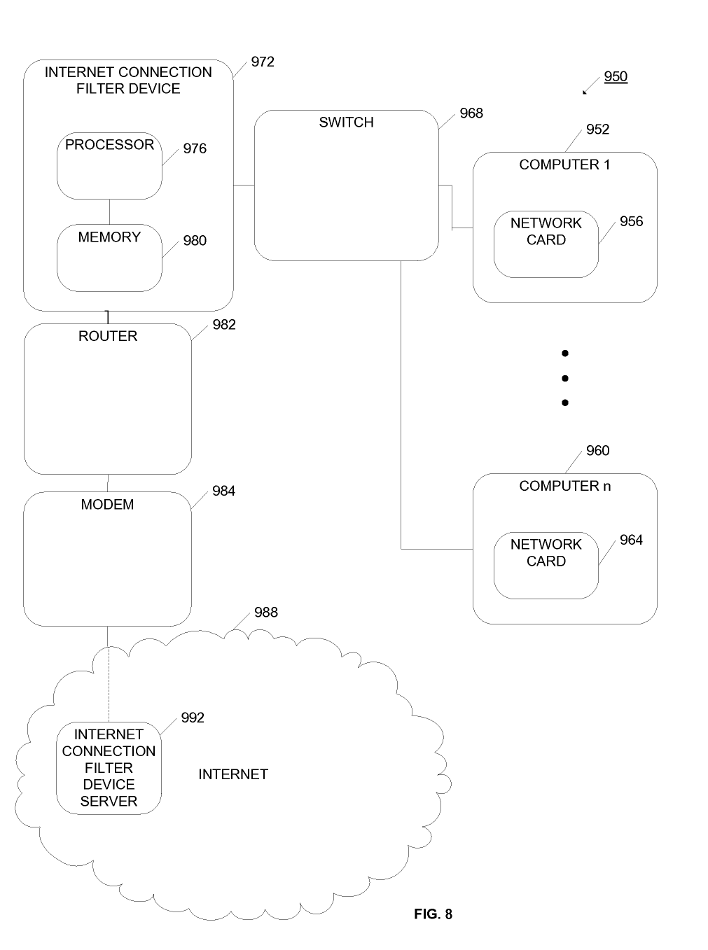

Referring now to FIG. 8, system 950 for enabling improved internet content filtering is illustrated. System 950 has router 982 connected to modem 984. It will be appreciated that the connection between router 982 and modem 984 may be a physical connection according to standards such as EIA/TIA 568 or a wireless connection according to standards such as IEEE 802.11. It will be further understood that modem 984 may convert between such standards as DSL, cable, phone lines, and EIA/TIS 568. Modem 984 is connected to internet 988 and internet connection filter device server 992.

Router 982 is also connected to internet connection filter device 972. It will be appreciated that the connection between router 982 and internet connection filter device 972 may be a physical connection according to standards such as EIA/TIA 568 or a wireless connection according to standards such as IEEE 802.11. In one example, internet connection filter device 972 will be assigned its own IP address by router 982. In another example, a user may manually enter an IP address for internet connection filter device 972. Internet connection filter device 972 is also connected to switch 968. It will be understood that the connection internet connection filter device 972 and switch 968 may be a physical connection according to standards such as EIA/TIA 568 or a wireless connection according to standards such as IEEE 802.11. Switches are know in the art and will not be described in detail. However, generally, switches direct traffic within a network. The messages transferred within the network under the direction of switch 968 contain the MAC address of the computer that originated them.

Computer 952 and computer 960 represent one or more computers connected to switch 968. It will be appreciated that theses connections may be physical and operate according to standards such as EIA/TIS 568 or that they may be wireless and operate according to standards such as IEEE 802.11.

In this configuration, internet connection filter device 972 has access to the MAC addresses in the messages being directed by the switch. In one example, internet connection filter device 972 uses the MAC address in the messages to differentiate between the traffic originating from each of the one or more computers on the network. Users can define rules sets to apply to each individual computer on the network. Advantageously, this allows users to restrict access to different access based on the particular computer being used. For example, if computer 952 is used by an employee performing acquisition responsibilities, shopping content can be enabled. Additionally, if computer 960 is being used exclusively for email, shopping content can be disabled. This ability to customize filtering for each computer on the network increases user satisfaction.

While the invention has been described in connection with a number of embodiments, it is not intended to limit the scope of the invention to the particular forms set forth, but no the contrary, it is intended to cover such alternatives, modifications, and equivalents as may be included within the scope of the invention.

What is claimed is:

1. An internet connection filter device, comprising:
a connection to a computer;
a connection to the internet;
a memory; and
a processor;
the processor performing the steps of:
storing categories of content to block in the memory;
requesting categories of content associated with a URL from an internet server; and
blocking access to the URL when a category of content associated with the domain matches a category of content to block stored in the memory.

2. The internet connection filter device according to claim 1, wherein the processor performs the additional steps of:
detecting a DNS request from the computer;
preventing the DNS request from being transmitted pending filtering; and
extracting the URL from the DNS request.

3. The internet connection filter device according to claim 1, wherein the processor performs the additional steps of:
detecting a get request from the computer;
preventing the get request from being transmitted pending filtering; and
extracting the URL from the get request.

4. The internet connection filter device according to claim 1, wherein the processor performs the additional steps of:
storing information identifying programs to block in the memory; and
blocking packets using protocols corresponding to programs to be blocked.

5. The internet connection filter device according to claim 1, wherein the processor performs the additional steps of:
storing information identifying programs to block in the memory; and
blocking packets directed to IP addresses associated with programs to be blocked.

6. The internet connection filter device according to claim 1, wherein the processor performs the additional steps of:
responding to DNS requests for blocked URL's by providing the IP address of the internet connection filter device; and
responding to get requests to directed to the internet connection control device with an html file indicating that the content of the URL is blocked.

7. The internet connection filter device according to claim 1, wherein the processor performs the additional step of:
responding to get requests for blocked URL's by with an html file indicating that the content of the URL is blocked.

8. The internet connection filter device according to claim 1, wherein the processor performs the additional steps of:
Associating the categories of content to be blocked in the memory with the MAC address of the computer.

9. A method for improved internet content filtering, comprising:
storing categories of content to block locally;
requesting categories of content associated with a domain from an internet server; and
blocking access to the domain when a category associated with the domain matches a locally stored category of content to block.

10. The method for improved content filtering according claim 9, further including the steps of:
detecting a DNS request;
preventing the DNS request from being transmitted pending filtering; and
extracting the URL from the DNS request.

11. The method for improved content filtering according claim 9, further including the steps of:
detecting a get request;
preventing the get request from being transmitted pending filtering; and
extracting the URL from the get request.

12. The method for improved content filtering according claim 9, further including the steps of:
storing information identifying programs to block locally; and
blocking packets using protocols corresponding to programs to be blocked.

13. The method for improved content filtering according claim 9, further including the steps of:
storing information identifying programs to block locally; and
blocking packets directed to IP addresses associated with programs to be blocked.

14. A method for enabling internet content filtering, operating on a server, comprising:
receiving a request for the categories of content associated with a URL;
obtaining the categories of content associated with the URL from a database; and
responding to the request with the categories of content associated with the URL.

15. A method for deterring identity theft, comprising:
determining if a URL in a get request contains an IP address; and
blocking access to the URL if the URL contains an IP address.
